(19) United States
(12) Patent Application Publication
(10) Pub. No.: US 2025/0138184 A1
(43) Pub. Date: May 1, 2025

(54) VEHICLE AND METHOD FOR PRECIPITATION DETECTION

(71) Applicant: HELLA GmbH & Co. KGaA, Lippstadt (DE)

(72) Inventor: Ludger WEGHAUS, Lippstadt (DE)

(73) Assignee: HELLA GmbH & Co. KGaA, Lippstadt (DE)

(21) Appl. No.: 18/933,738

(22) Filed: Oct. 31, 2024

(30) Foreign Application Priority Data
Oct. 31, 2023 (DE) 10 2023 130 055.5

(51) Int. Cl. G01S 13/95; B60S 1/08; B60W 30/14; G01S 13/02

(52) U.S. Cl. CPC G01S 13/95; B60S 1/0822; G01S 13/0209; B60W 30/143; B60W 2555/20

(57) ABSTRACT

A vehicle that includes at least one UWB transmitting antenna unit that is configured to emit a radio signal pulse in a defined transmission frequency range, at least one UWB receiving antenna unit that is configured to receive radio signals in the transmission frequency range, and a processing unit that is configured to evaluate the signal strength pattern of the radio signal received by the UWB receiving antenna unit. The processing unit includes a precipitation detection module that is designed to ascertain precipitation based on a signal strength pattern of the radio signal received by the UWB receiving antenna unit.

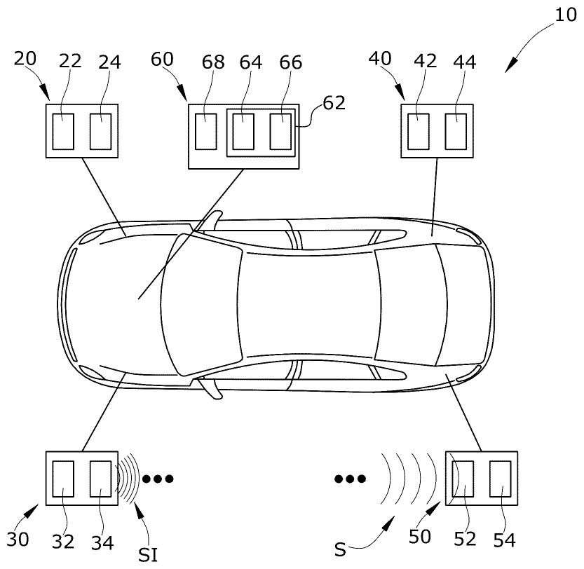

This nonprovisional application claims priority under 35 U.S.C. § 119(a) to German Patent Application No. 10 2023 130 055.5, which was filed in Germany on Oct. 31, 2023, and which is herein incorporated by reference.

### BACKGROUND OF THE INVENTION

### Field of the Invention

The present invention relates to a vehicle and to a method for precipitation detection.

### Description of the Background Art

Precipitation detection carried out by a vehicle is already known per se from the prior art. In particular, so-called rain sensors and visibility sensors are known. By use of the rain sensor, the layer of water or snow caused by raindrops or snowflakes and depositing on the windshield is detected, and on this basis rainfall or snowfall is deduced. By use of the visibility sensor, aerosols and small dust particles, such as those occurring in fog, smoke, or smog, are detected, and on this basis fog, smoke, or smog and therefore reduced visibility are deduced. Both variants are generally designed in the form of an optical sensor and are situated at an inner side of a windshield. During operation of the rain sensors or visibility sensors designed as optical sensors, light beams are emitted in a targeted manner, and based on the reflection of the emitted light beams it is determined whether reduced visibility due to rainfall, snowfall, fog, and/or smoke is present. A drawback of such rain sensors and visibility sensors designed as optical sensors is that they are susceptible to interference when the sensor is soiled.

### SUMMARY OF THE INVENTION

It is therefore an object of the invention to provide a vehicle with which precipitation detection can take place in a simple, cost-effective, and reliable manner.

In an example, a vehicle according to the invention includes at least one UWB transmitting antenna unit that is configured to emit a radio signal pulse in a defined transmission frequency range, and at least one UWB receiving antenna unit that is configured to receive radio signals in the transmission frequency range. The transmission frequency range is preferably 6.5-8.0 GHz.

The UWB transmitting antenna unit and the UWB receiving antenna unit are based on ultra-wideband (UWB) technology, which is basically known and which in principle allows data transfer over short distances at a relatively high data transfer rate. These types of UWB transmitting antenna units and UWB receiving antenna units based on ultra-wideband technology are generally used in automotive technology. In particular, the UWB transmitting antenna unit and the UWB receiving antenna unit are integral parts of a wireless remote control system, wherein the wireless remote control system is used for control of access into the vehicle. In particular, via a signal transmission between the vehicle and a mobile device that is present in the surroundings of the vehicle, a person who is authorized to unlock the vehicle is recognized, and on this basis the vehicle doors are unlocked or automatically opened.

During the transmission, the radio signal is generally influenced due to environmental effects, so that the radio signal received by the UWB receiving antenna unit is different from the radio signal emitted by the UWB transmitting antenna unit. In particular, depending on the surroundings, the radio signal received by the UWB receiving antenna unit may include a different number of reflections of the emitted radio signal. Since the transmission path between the UWB transmitting antenna unit and the UWB receiving antenna unit is also called a radio channel, the radio signal received by the UWB receiving antenna unit is also referred to as a channel impulse response (CIR). The UWB transmitting antenna unit is preferably configured to emit a defined sequence of radio signal pulses. The radio signal pulses emitted by the UWB transmitting antenna unit typically have a pulse duration in the range of nanoseconds.

The vehicle also includes a processing unit that is configured to evaluate the signal strength pattern of the radio signal received by the UWB receiving antenna unit. The processing unit typically includes a microcontroller or some other type of programmable arithmetic unit, wherein the functionality of the processing unit may be implemented in hardware and/or software. The processing unit may be implemented as a separate component to be mounted on the vehicle, or alternatively, together with the UWB transmitting antenna unit and/or the UWB receiving antenna unit, may be implemented in a shared device. In addition, it is also conceivable for the processing unit to be formed by a control unit that is already present in the vehicle or by some other programmable arithmetic unit that is already present, which is coupled at least to the UWB receiving antenna unit and appropriately programmed, for example by running a software component.

Since the UWB transmitting antenna unit is typically configured to emit the radio signal pulse at a relatively large solid angle, and the UWB receiving antenna unit is typically configured to receive radio signals that arrive at a relatively large solid angle, the received radio signal generally contains one or more reflections of the emitted radio signal pulse, which due to the longer transmission path arrive at the UWB receiving antenna unit in a time-offset manner relative to the unreflected radio signal pulse. The number of reflections contained in the received radio signal is a function of an effective reflectivity of the surroundings, which in particular depends on the number, size, and surface properties of objects present in the surroundings. In addition, a maximum signal strength is generally also a function of the effective reflectivity of the surroundings.

The processing unit includes a precipitation detection module or a weather detection module that is designed to ascertain precipitation based on a signal strength pattern of the radio signal received by the UWB receiving antenna unit.

In particular, the precipitation detection module can be configured to evaluate the entire so-called CIR of the UWB receiving antenna unit with regard to the precipitation that is present. The precipitation detection module may be configured, for example, to ascertain the number of deflections, i.e., peaks, within a defined interval of the CIR, and to recognize precipitation that is present, based on the ascertained number or type of deflections. In principle, the processing unit may be configured to evaluate any given property of the pattern of the CIR, which changes as a function of the number of reflections, in order to recognize precipitation on this basis.

In particular, the precipitation detection module can be designed to recognize certain signal strength patterns, and on this basis to deduce precipitation. For rainfall, snowfall, or fog, the signal strength pattern has a relatively large number of peaks that are caused by the individual liquid drops or snowflakes present in the ambient air. When such a signal strength pattern is detected, it is determined that rainfall, snowfall, or fog is present. The identified precipitation may be subsequently utilized for other systems of the vehicle.

Precipitation detection may thus be carried out in a simple and reliable manner. In particular, technology and the components for the precipitation detection, necessary for this purpose, which are already present in numerous vehicles for some other purpose and operating in a completely different manner, may be used.

The precipitation detection module can be designed to ascertain the precipitation based on a plurality of deflections, caused by the liquid drops and/or snowflakes, having different signal pathways. The water droplets causing raindrops, snowflakes, and fog and present in the vehicle surroundings or in the ambient air result in a certain reflection of the electromagnetic beams, and thus a signal strength pattern that characterizes rainfall, snowfall, and fog, wherein the signal strength pattern has a relatively large number of similar deflections, i.e., peaks, having different signal strengths. When such a signal strength pattern is detected by the precipitation detection module, precipitation is present.

The precipitation detection module can be designed to determine the reflections, caused by the raindrops, liquid drops, and/or snowflakes, having different signal pathways by applying the Doppler effect and the vehicle speed. The Doppler effect is understood to mean an apparent change in the frequency of sound, light, or radio waves caused by the relative motion between a source and an observer. The frequency increases when the source and the observer move toward one another. When the source and the observer move away from one another, the frequency decreases.

When the vehicle is traveling in the presence of precipitation, the vehicle essentially moves at the vehicle speed toward the raindrops, the snowflakes, and the water droplets causing the fog. By ascertaining the change in the frequency shift of individual regions of the signal strength pattern, in particular the peaks, it is also possible to determine the relative speed between the vehicle and a reflective element. By comparing the determined relative speeds and the known speed of the vehicle, the reflections or peaks that are associated with the rain drops, snowflakes, or water droplets may be determined. The determined relative speeds correspond essentially to the vehicle speed. In this way, the regions of the signal strength pattern that are crucial for identifying precipitation may be reliably determined.

The vehicle can include multiple UWB receiving antenna units that are spaced apart from one another in the vehicle transverse direction and/or in the vehicle longitudinal direction, and which in each case are configured to receive radio signals in the transmission frequency range, wherein the radio signals read by the multiple UWB receiving antenna units are evaluatable by the processing unit, and/or multiple UWB transmitting antenna units, spaced apart from one another in the vehicle transverse direction and/or in the vehicle longitudinal direction, which in each case are configured to emit a radio signal pulse in a defined transmission frequency range, and a control unit that is configured to control the multiple UWB transmitting antenna units in such a way that the radio signal pulse may be selectively emitted by each of the UWB transmitting antenna units. Due to providing multiple UWB receiving antenna units and/or multiple UWB transmitting antenna units, the precipitation detection may take place based on multiple signal strength patterns, wherein the precipitation detection module analyzes the signal strength patterns in each case for precipitation that is present. The precipitation may thus be determined in a particularly reliable manner.

At least one transceiver device can be provided which includes a UWB transmitting antenna unit as well as a UWB receiving antenna unit, and the transceiver device is configured to simultaneously operate the UWB transmitting antenna unit and the UWB receiving antenna unit. The UWB transmitting antenna unit and a UWB receiving antenna unit may thus be compactly integrated into a transceiver device, so that the number of components to be installed may be reduced. Due to the simultaneous operation of the UWB transmitting antenna unit and the UWB receiving antenna unit, a radio signal pulse emitted by the UWB transmitting antenna unit of the transceiver device may be reliably received by the UWB receiving antenna unit of the same transceiver device.

The vehicle can include a fog light function, an automatic vehicle speed function, an automatic windshield wiper function, and/or a warning function that are activatable based on a precipitation value that is output by the precipitation detection module. Driving safety may thus be increased due to the fact that at least one of the functions is automatically activated when precipitation is ascertained by the precipitation module.

Moreover, the object is achieved by a method for precipitation detection with the vehicle. With regard to the advantages of the method, reference is made to the preceding paragraphs.

Precipitation detection may thus be easily and reliably carried out. In particular, technology and the components for the precipitation detection, necessary for this purpose, which are already present in numerous vehicles for some other purpose and operating in a completely different manner, may be used.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawings which are given by way of illustration only, and thus, are not limitive of the present invention, and wherein the sole figure schematically shows a vehicle according to the invention together with a processing unit and four transceiver devices, each of which includes a transmitting antenna unit and a receiving antenna unit.

### DETAILED DESCRIPTION

The figure shows in a schematic manner a vehicle 10 according to the invention, including four transceiver devices 20, 30, 40, 50 and a control device 60.

All the transceiver devices 20, 30, 40, 50 included in the vehicle 10 have identical designs, and are each mounted in the area of a bumper or a fender of the vehicle 10. In particular, two transceiver devices 20, 30 are mounted at the front end, and two transceiver devices 40, 50 are mounted at the rear end of the vehicle 10, the transceiver devices 20, 40 being mounted on the front passenger side 12 and the transceiver devices 30, 50 being mounted on the driver's side 14.

The four transceiver devices 20, 30, 40, 50 are based on known ultra-wideband technology, and include a UWB transmitting antenna unit 22, 32, 42, 52 and a UWB receiving antenna unit 24, 34, 44, 54, respectively. The UWB transmitting antenna unit 22, 32, 42, 52 is configured to emit, in a known manner, a wideband radio signal pulse SI in a defined transmission frequency range, and the UWB receiving antenna unit 24, 34, 44, 54 is configured to receive, in a known manner, radio signals S in the transmission frequency range used by the UWB transmitting antenna unit 22, 32, 42, 52. The four transceiver devices 20, 30, 40, 50 are each configured to simultaneously operate the respective UWB transmitting antenna unit 22, 32, 42, 52 and the respective UWB receiving antenna unit 24, 34, 44, 54, i.e., to operate them in such a way that the respective UWB receiving antenna unit 24, 34, 44, 54 receives radio signals S, while the respective UWB transmitting antenna unit 22, 32, 42, 52 emits the radio signal pulse SI.

The control device 60 here is situated in an engine compartment of the vehicle 10 by way of example, but in principle may be mounted at any desired location in the vehicle 10. The control device 60 includes a processing unit 62 and a control unit 68, and is typically coupled to the four transceiver devices 20, 30, 40, 50 via a cable connection.

The control unit 68 is configured to control the four transceiver devices 20, 30, 40, 50. In particular, the control unit 68 is configured to control the transceiver devices 20, 30, 40, 50 in such a way that the radio signal pulse SI may be selectively emitted by the respective UWB transmitting antenna unit 22, 32, 42, 52 of each of the four transceiver devices 20, 30, 40, 50.

The processing unit 62 is configured to evaluate the signal strength patterns of the radio signals S received by the UWB receiving antenna units 22, 32, 42, 52 of the four transceiver devices 20, 30, 40, 50, in particular to evaluate a pattern of a magnitude of the so-called CIR of the corresponding UWB receiving antenna unit 22, 32, 42, 52. For this purpose, according to the invention the processing unit 62 includes a precipitation detection module 64 that is designed to recognize precipitation in the vehicle surroundings based on the signal strength pattern of the UWB receiving antenna units 24, 34, 44, 54.

In particular, the precipitation detection module 64 is designed to recognize certain signal strength patterns of the radio signals S of the UWB receiving antenna units 22, 32, 42, 52, and on this basis to deduce precipitation. For rainfall, snowfall, or fog, the signal strength pattern has a relatively large number of peaks that are caused by the individual liquid drops or snowflakes present in the ambient air. When such a signal strength pattern is detected, it is determined that rainfall, snowfall, or fog is present.

To allow precipitation to be detected in a particularly reliable manner, the precipitation detection module 64 is designed to determine the reflections, caused by the liquid drops and/or snowflakes, having different signal pathways by applying the Doppler effect and the vehicle speed. The Doppler effect is understood to mean an apparent change in the frequency of sound, light, or radio waves caused by the relative motion between a source and an observer. The frequency increases when the source and the observer move toward one another. When the source and the observer move away from one another, the frequency decreases.

When the vehicle 10 is traveling in the presence of precipitation, the vehicle 10 moves at the certain vehicle speed toward the raindrops, the snowflakes, and the water droplets causing the fog. By ascertaining the change in the frequency shift of individual regions of the signal strength pattern, in particular the peaks, it is possible to determine the relative speed between the vehicle 10 and a reflective element that causes the deviation; by comparing the determined relative speeds and the speed of the vehicle 10, the reflections or peaks that are associated with the raindrops, snowflakes, or water droplets may be determined. In this way, the deflections of the signal strength pattern may be associated with the raindrops, water droplets, or snowflakes in a relatively precise manner.

The control device 60 or the processing unit 62 also includes a communication interface 66 for coupling to a system that influences the driving operation, the system being used to operate a fog light function, an automatic vehicle speed function, an automatic windshield wiper function, and/or an output of a warning function. When precipitation is detected by the precipitation detection module 64, a precipitation signal is transmitted to the system via the communication interface 66, thus activating the fog light function, the automatic vehicle speed function, the automatic windshield wiper function, and/or the output of a warning function, based on the precipitation signal.

A vehicle 10 is thus provided via which the precipitation detection can be easily and reliably carried out. In particular, technology and the components for the precipitation detection, necessary for this purpose, which are already present in numerous vehicles for some other purpose and operating in a completely different manner, may be used.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A vehicle comprising:
at least one UWB transmitting antenna unit that is configured to emit a radio signal pulse in a defined transmission frequency range;
at least one UWB receiving antenna unit that is configured to receive radio signals in the transmission frequency range; and
a processing unit that is configured to evaluate the signal strength pattern of the radio signal received by the UWB receiving antenna unit,
wherein the processing unit include a precipitation detection module that is designed to ascertain precipitation based on a signal strength pattern of the radio signal received by the UWB receiving antenna unit.

2. The vehicle according to claim 1, wherein the precipitation detection module is designed to recognize a signal strength pattern that is influenced by liquid drops and/or snowflakes present in the surroundings, and on this basis to ascertain the precipitation.

3. The vehicle according to claim 2, wherein the precipitation detection module is designed to determine, based on the signal strength pattern, a plurality of reflections, having different signal pathways, caused by the liquid drops and/or snowflakes, and on this basis to ascertain the precipitation.

4. The vehicle according to claim 3, wherein the precipitation detection module is designed to determine the reflections, having different signal pathways, caused by the liquid drops and/or snowflakes by applying a Doppler effect and the vehicle speed.

5. The vehicle according to claim 1, further comprising:
at least two UWB receiving antenna units that are spaced apart from one another in the vehicle transverse direction and/or in the vehicle longitudinal direction, each of which is configured to receive radio signals in the transmission frequency range, wherein the signal strength patterns of the radio signals(S) received by the UWB receiving antenna units are evaluable by the processing unit, and/or wherein the at least two UWB transmitting antenna units spaced apart from one another in the vehicle transverse direction and/or in the vehicle longitudinal direction, each of which is configured to emit a radio signal pulse in a defined transmission frequency range; and
a control unit configured to control the at least two UWB transmitting antenna units such that the radio signal pulse is selectively emitted by each of the UWB transmitting antenna units.

6. The vehicle according to claim 1, further comprising:
at least one transceiver that includes a UWB transmitting antenna unit as well as a UWB receiving antenna unit, wherein the transceiver is configured to substantially simultaneously operate the UWB transmitting antenna unit and the UWB receiving antenna unit.

7. The vehicle according to claim 1, wherein the UWB transmitting antenna unit and the UWB receiving antenna unit are associated with a wireless remote control system.

8. The vehicle according to claim 1, further comprising:
a fog light function, an automatic vehicle speed function, an automatic windshield wiper function, and/or a warning function are activatable based on a precipitation signal that is output by the precipitation detection module.

9. A method for precipitation detection, the method comprising:
providing the vehicle according to claim 1; and
detecting a precipitation.
